(19) United States
(12) Patent Application Publication
(10) Pub. No.: US 2019/0003606 A1
(43) Pub. Date: Jan. 3, 2019

(54) ELECTRO-MECHANICAL PRESSURE RELIEF VALVE

(71) Applicant: Halliburton Energy Services, Inc., Houston, TX (US)

(72) Inventors: Robert Cecil MOGER, IV, Duncan, OK (US); Brad Robert BULL, Duncan, OK (US)

(21) Appl. No.: 16/074,611

(22) PCT Filed: Jun. 27, 2016
(86) PCT No.: PCT/US2016/039540

§ 371 Date: Aug. 1, 2018

(51) Int. Cl. F16K 15/18

(52) U.S. Cl. CPC F16K 15/18

(57) ABSTRACT

Examples of a pressure relief valve are provided. An example pressure relief valve comprises a main seal ring, a poppet configured to form a seal with the main seal ring, a dynamic wear sleeve configured to cover the main seal ring when the pressure relief valve is at least partially open and comprising a reduced cross-sectional area of the inner diameter at one end of the dynamic wear sleeve, an electro-mechanical clutch assembly, and wherein the pressure relief valve is actuated by the electro-mechanical clutch assembly.

### TECHNICAL FIELD

The present disclosure relates to a pressure relief valve for relieving overpressure in a flow line and more particularly to a pressure relief valve which is maintained in its default closed position by an electro-mechanical clutch assembly which is not powered by hydraulics or pneumatics.

### BACKGROUND

Pressure relief valves may be used to protect flow lines and equipment from overpressure events. Pressure relief valves may include an inlet in fluid communication with a flow line, an outlet coupled to the inlet and in fluid communication to a vent line, and a movable valve element configured to isolate the outlet from the inlet and thereby block fluid communication between the two. Some current models of pressure relief valves require rebuilding after one to three full activations because the sealing element may become damaged. In order to reduce pressure relief valve rebuilding and replacement of the sealing element, burst discs have been used. Although burst discs may be cheaper than rebuilding the pressure relief valve and may be replaced in less time than the rebuild, the burst discs may only be used once per overpressure event and are still expensive to replace.

Other types of pressure relief valves utilize hydraulic fluid to actuate the valve. These hydraulic pressure relief valves necessitate that a hydraulic fluid be kept in a sealed fluid chamber until an overpressure event is detected which requires the pressure relief valve to be actuated. When an overpressure event occurs, the hydraulic fluid valve within the pressure relief valve releases the hydraulic fluid within the sealed fluid chamber to actuate the pressure relief valve and relieve the overpressure in the flow line. However these hydraulic fluid valves may leak hydraulic fluid out of the fluid chamber if the seal is damaged. Further, the size of these pressure relief valves must be large enough to contain the fluid chamber and the corresponding hydraulic fluid, and as such they add additional complexity and expense.

Other types of pressure relief valves utilize pneumatics to actuate the valve. These types of pneumatic pressure relief valves utilize a large pressure cylinder filled with a compressible gas. The pressure in the pressure cylinder may be limited by the available gas storage supply and may require that the area of the piston be sufficiently larger than the area of the valve element which seals the inlet. In addition, the gas pressure in the cylinder must be maintained at a predetermined set point pressure to allow the valve element to open at the desired maximum line pressure. These types of pressure relief valves may require a high pressure gas bottle and multiple hoses, and as such they add additional complexity and expense.

### BRIEF DESCRIPTION OF THE DRAWINGS

Illustrative examples of the present disclosure are described in detail below with reference to the attached drawing figures, which are incorporated by reference herein, and wherein:

FIG. 1 is a cross-section of a pressure relief valve illustrated in the closed mode of operation;

FIG. 2 is a cross-section of a pressure relief valve illustrated in the open mode of operation;

FIG. 3 is a cross-section of an electro-mechanical clutch assembly illustrated in the closed mode of operation;

FIG. 4 is a cross-section of an electro-mechanical clutch assembly illustrated in the open mode of operation;

FIG. 5 is an isometric view of a poppet lock ring in isolation.

The illustrated figures are only exemplary and are not intended to assert or imply any limitation with regard to the environment, architecture, design, or process in which different examples may be implemented.

### DETAILED DESCRIPTION

The present disclosure relates to a pressure relief valve for relieving overpressure in a flow line and more particularly to a pressure relief valve which is maintained in its default closed position by an electro-mechanical clutch assembly which is not powered by hydraulics or pneumatics.

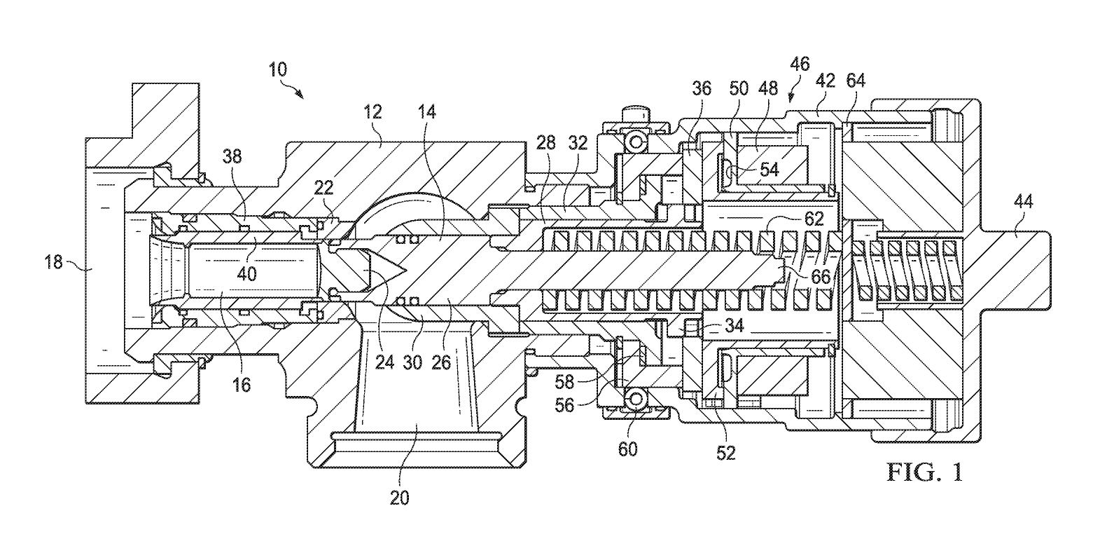

The pressure relief valve may comprise an electro-mechanical clutch assembly. The electro-mechanical clutch assembly may be actuated to open the pressure relief valve to relieve the pressure in a flow line during an overpressure event in said flow line. For example, the electro-mechanical clutch assembly may release a poppet latch ring and allow a poppet to be unlocked such that a seal formed by the poppet and a main seal ring is unsealed. The removal of the seal opens fluid communication between an inlet coupled to the flow line and an outlet coupled to a vent line. Further, the examples disclosed herein also comprise a dynamic wear sleeve which reduces erosion of the main seal ring and increases the useful life of the pressure relief valve, such that the pressure relief valve may be activated several times before a rebuild is required. Embodiments of the present disclosure and its advantages may be understood by referring to FIGS. 1 through 5, where like numbers are used to indicate like and corresponding parts.

Examples of the pressure relief valve will now be described with reference to FIG. 1. In this example, the pressure relief valve, generally 10, is illustrated in cross-section in the closed mode of operation. The closed mode of operation is the default mode of operation for pressure relief valve 10. In the closed mode of operation, pressure relief valve 10 does not relieve pressure in a flow line. Pressure relief valve 10 comprises a pressurized valve body 12 and a poppet 14 which is disposed within the pressurized valve body 12. The pressurized valve body 12 comprises an inlet 16 which is coupled to a flow line port 18. Flow line port 18 is in fluid communication with a flow line (not shown). The pressurized valve body 12 further comprises an outlet 20 which may be coupled to a vent line (not shown). The poppet 14 extends within pressurized valve body 12 to form a seal with main seal ring 22. In the example illustrate in FIG. 1, the seal formed between the poppet 14 and the main seal ring 22 blocks fluid communication between the inlet 16 and the outlet 20. Poppet 14 is illustrated as a poppet assembly comprising poppet sealing member 24, poppet body member 26, and poppet contact member 28. At least a portion of poppet sealing member 24 forms the seal with main seal ring 22. Poppet body member 26 is slidably engaged with poppet seal ring 30. Poppet seal ring 30 allows poppet 14 to move within poppet seal ring 30 and maintains a seal around the portion of poppet 14 in contact with poppet seal ring 30 such that when the pressure relief valve is in the open mode of operation, fluid entering from inlet 16 flows through outlet 20 and does not flow past the seal formed between poppet seal ring 30 and poppet 14. Poppet contact member 28 is slidably engaged with poppet guide 32. Poppet guide 32 guides poppet 14 within the pressure relieve valve 10 as desired. Poppet contact member 28 comprises a contact element 34 which is pressed against poppet lock ring 36 when pressure relief valve 10 is in the closed mode of operation as will be explained in greater detail below. Although poppet 14 is depicted as an assembly of three components, it is to be understood that poppet 14 may be constructed as one continuous piece comprising the poppet sealing member 14, poppet body member 26, and the poppet contact member 28.

With continued reference to FIG. 1, pressurized relief valve 10 further comprises static wear sleeve 38 and dynamic wear sleeve 40 disposed within pressurized valve body 12. Static wear sleeve 38 may be positioned within pressurized valve body 12 adjacent to main seal ring 22. Static wear sleeve 38 may be affixed to a surface of pressurized valve body 38 such that static wear sleeve 38 does not move within pressurized valve body 38. Static wear sleeve 38 may also be positioned proximate to flow line port 18 and inlet 16. Dynamic wear sleeve 40 may be at least partially disposed within static wear sleeve 38. Dynamic wear sleeve 40 may also be positioned proximate poppet 14 and flow line port 18 and adjacent inlet 16. Dynamic wear sleeve 40 may be positioned within pressurized valve body 12 and static wear sleeve 38 such that dynamic wear sleeve 40 may contact flow within inlet 16. In the closed mode of operation illustrated by FIG. 1, the dynamic wear sleeve 40 is proximate the seal formed between poppet 14 and main seal ring 22. As will be discussed in more detail below, in the open mode of operation, the seal formed between poppet 14 and main seal ring 22 is removed, and the main seal ring 22 is protected from erosion by flow through inlet 16 by dynamic wear sleeve 40 which may be pushed by said flow through inlet 16 to a position where dynamic wear sleeve 40 covers at least a portion of main seal ring 22. This covering of main seal ring 22 by dynamic wear sleeve 40 in the open mode of operation, may increase the useful life of main seal ring 22. Dynamic wear sleeve 40 may also comprise a tapered interior surface area that provides a reduced cross-sectional area at the section of the inner diameter adjacent to the main seal ring 22 relative to the cross-sectional area of the inner diameter adjacent to the inlet 16 resulting in an inner diameter that decreases in cross-sectional area as fluid flows through the dynamic wear sleeve 40 from the inlet 16 to the outlet 20 (i.e. a reduction in the size of the fluid flow path through the pressurized valve body 12). As such, fluid flowing through the dynamic wear sleeve 40 may be choked and slowed resulting in a reduction in fluid velocity through dynamic wear sleeve 40. This reduction in fluid velocity may result in an overall increase in erosion of dynamic wear sleeve 40 and an overall decrease in erosion of interior valve surfaces downstream of dynamic wear sleeve 40.

With continued reference to FIG. 1, a housing 42, is coupled to the pressurized valve body 12 and a housing cap 44. Disposed within housing 42 is the electro-mechanical clutch assembly, generally 46. The electro-mechanical clutch assembly 46 may comprise any or all of an electromagnetic coil 48, a first clutch ring 50, a second clutch ring 52, a clutch biasing element 54, a swivel ring 56, a bearing 58, a biasing element 60, and the poppet lock ring 36. As will be illustrated in more detail below, electromagnetic coil 48 biases first clutch ring 50 towards and against second clutch ring 52 such that movement of second clutch ring 52 is restricted. Clutch biasing element 54 is disposed between first clutch ring 50 and second clutch ring 52 and biases second clutch ring 52 away from first clutch ring 50 such that movement of second clutch ring 52 is not restricted. The biasing force exerted by clutch biasing element 54 may be overcome by the power of electromagnetic coil 48 as desired such that electromagnetic coil 48 may bias first clutch 50 towards and against second clutch ring 52 to restrict the movement of second clutch ring 52 despite the biasing force exerted by clutch biasing element 54. Electromagnetic coil 48 may be any sufficient electric power source for biasing first clutch 50 towards and against second clutch ring 52. Clutch biasing element 54 may be any biasing element sufficient for biasing second clutch ring 52 away from first clutch ring 50 when electromagnetic coil 48 is not sufficiently biasing first clutch ring 50 towards and against second clutch ring 52. An example of clutch biasing element 54 is a spring. Although two clutch rings are depicted, it is to be understood that the illustrated example may be modified to include more than two clutch rings as desired, for example, the electro-mechanical clutch assembly 46 may comprise a plurality of clutch rings including three, four, five, six, or more clutch rings as desired.

The electromagnetic coil 48 may be powered via a conduit connection to a power source external to the pressure relief valve 10. In some alternative examples, the electromagnetic coil 48 may be coupled to a power source within the pressure relief valve, for example, a battery. The electromagnetic coil 48 biases the first clutch ring 50 against the second clutch ring 52 without the use of pneumatics or hydraulics. When signaled, the electromagnetic coil 48 may reduce power or turn off such that the electromagnetic coil 48 no longer biases the first clutch ring 50 against the second clutch ring 52. This signal may be transmitted via a pressure transducer which transmits a signal to the electromagnetic coil 48 when an overpressure event is occurring in the flow line. The pressure transducer may be preprogrammed to send said signal when the pressure in the flow line exceeds a threshold. Alternatively, the electromagnetic coil 48 may be programmed to release automatically when power to the electromagnetic coil 48 is not sufficient to bias first clutch ring 50 against second clutch ring 52. As such, in some examples, a pressure transducer may not be needed to actuate the pressure relief valve 10. For example, the electro-mechanical clutch assembly may be actuated without a pressure transducer by supplying a discrete amount of power as desired.

The electro-mechanical clutch assembly 46 further comprises the poppet lock ring 36 which is coupled to second clutch ring 52 and swivel ring 56. As described above, when in the closed mode of operation, poppet lock ring 36 contacts the contact element 34 of the poppet contact member 28. When the first clutch ring 50 is engaged with the second clutch ring 52, axial rotation of the second clutch ring 52 is restricted and consequently axial rotation of the poppet lock ring 36 is also restricted. Because axial rotation of poppet lock ring 36 is restricted, force exerted by contact element 34 against poppet lock ring 36 (e.g., force against poppet sealing member 24 of poppet 14) does not induce axial rotation of poppet lock ring 36. Swivel ring 56 comprises a biasing element 60 which induces the swivel ring 56 to axially rotate within housing 42 to reset the electro-mechanical clutch assembly 46 when the overpressure event has been sufficiently relieved. Specifically, because swivel ring 56 is coupled to poppet lock ring 36, which is further coupled to second clutch ring 52. Biasing element 60 may swivel the swivel ring 56, and consequently the poppet lock ring 36 and second clutch ring 52 to return to the position indicated in FIG. 1 (i.e., the default closed mode of operation) after an overpressure event has occurred.

Swivel ring 56 may be coupled to poppet guide 32 via bearing 58 which allows for movement of swivel ring 56 relative to poppet guide 32. When the second clutch ring 52 is disengaged from the first clutch ring 50, flow pressure from an overpressure event may enter inlet 16 and may push the poppet seal member 24 of poppet 14 within poppet guide 32 such that the contact element 34 of the poppet contact member 28 induces axial rotation of poppet lock ring 36 and allows the poppet contact member 28 to slide past poppet lock ring 36 and the poppet 14 may slide within poppet guide 32 out of inlet 16. When poppet 14 slides a sufficient amount out of inlet 16 and away from main seal ring 22, the seal formed between poppet 14 and main seal ring 22 may be broken and the pressure relief valve 10 is transitioned to its open mode of operation which comprises allowing inlet 16 to be in fluid communication with outlet 20. Although outer clutch ring 52, poppet lock ring 36, and swivel ring 56 are illustrated as separate components which have been coupled together. It is to be understood that any of the aforementioned components may comprise one continuous piece with any other of the aforementioned components.

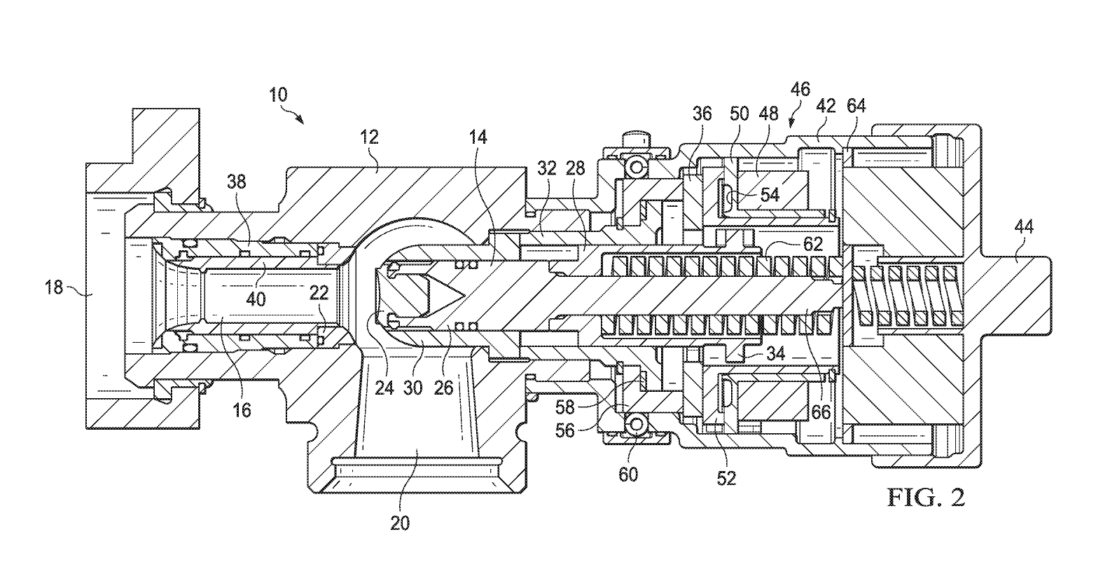

FIG. 2 illustrates pressure relief valve 10 in its open mode of operation. In the open mode of operation, electromagnetic coil 48 does not bias first clutch ring 50 against second clutch ring 52. Clutch biasing element 54 biases second clutch ring 52 away from first clutch ring 50 such that second clutch ring 52 is not engaged with first clutch ring 50 and the axial rotational movement of second clutch ring 52 is not restricted by engagement of second clutch ring 52 with first clutch ring 50. Axial rotation of poppet lock ring 36, and consequently second clutch ring 52 and swivel ring 56, is induced by flow pressure (i.e., flow pressure via flow line port 18 into inlet 16 from an overpressure event) against poppet seal member 24 of poppet 14 such that a portion of the force exerted by said flow pressure is transferred to the contact element 34 of poppet contact member 28. The contact element 34 thus exerts a force against poppet lock ring 36 that induces said rotation of poppet lock ring 36 in the axial direction. When poppet lock ring 36 is axially rotated a sufficient distance, the poppet contact element 34 of poppet contact member 28 may be allowed to move to the other side of poppet lock ring 36 such that poppet 14 may then be moved out of inlet 16 by the force of the flow pressure. The seal formed by poppet seal member 24 with main seal ring 22 may be broken when poppet 14 is moved out of inlet 16 and fluid communication between inlet 16 and outlet 20 may then be established.

With continued reference to FIG. 2, flow through inlet 16 from flow line port 18 may also shift dynamic wear sleeve 40 over main seal ring 22 as illustrated in FIG. 2 when poppet 14 no longer forms a seal with main seal ring 22. Dynamic wear sleeve 40 may cover and protect at least a portion of main seal ring 22 from erosive forces when pressure relief valve 10 is in its open mode of operation by reducing contact of main seal ring 22 from the flow entering pressure relief valve 10 via flow line port 18 and inlet 16 during an overpressure event. During an overpressure event the dynamic wear sleeve 40 may provide a reduction of area in the inlet 16 that allows for slowing the fluid as passes through the pressurized valve body 12 which may increase erosion of the dynamic wear sleeve 40 but decrease erosion on other valve interior surfaces downstream. Poppet seal ring 30 may prevent said flow during an overpressure event from bypassing poppet 14 and entering housing 42. In the open mode of operation, during an overpressure event, flow entering via flow line port 18 and inlet 16 is directed through inlet 16 and into outlet 20 as illustrated in FIG. 2. Flow through outlet 20 may enter a vent line (not illustrated) and exit pressure relief valve 10 so long as fluid communication between inlet 16 and outlet 20 is maintained.

As illustrated in FIG. 2, poppet spring 62, a component of poppet body member 26 may be compressed against an interior portion of housing cap 44. Impact plate 64 may contact the tail end 66 of poppet body member 26 such that poppet body member 26 is halted from further movement. Bumper 66 and bumper spring 68 may be used to support and buttress impact plate 64 from impact of the tail end 66 of poppet body member 26 against impact plate 64. When the flow pressure against poppet 14 from the overpressure event is reduced below a desirable threshold (i.e. when a sufficient amount of pressure is relieved to reduce the pressure in the flow line below said threshold), the spring force from poppet spring 62 may bias poppet 14 into inlet 16 such that poppet 14 forms a seal against main seal ring 22 and inlet 16 is no longer in fluid communication with outlet 20. The electro-mechanical clutch assembly 46 may then reset such that swivel ring 56, poppet lock ring 36, and second clutch ring 52 are axially rotated back into their default position illustrated in FIG. 1 by biasing element 60 axially rotating the swivel ring 56, and consequently poppet lock ring 36 and second clutch ring 52, into their default positions corresponding with the closed mode of operation. Contact element 34 of poppet contact member 28 may be reverted back to its default position when poppet spring 62 biases poppet 14 into inlet 16. Electromagnetic coil 48 may bias first clutch ring 50 against second clutch ring 52 to prevent axial rotation of second clutch ring 52, and consequently poppet lock ring 36 and swivel ring 56, by flow pressure against poppet 14 as discussed above. As such, the pressure relief valve 10 has reentered the closed mode of operation illustrated in FIG. 1.

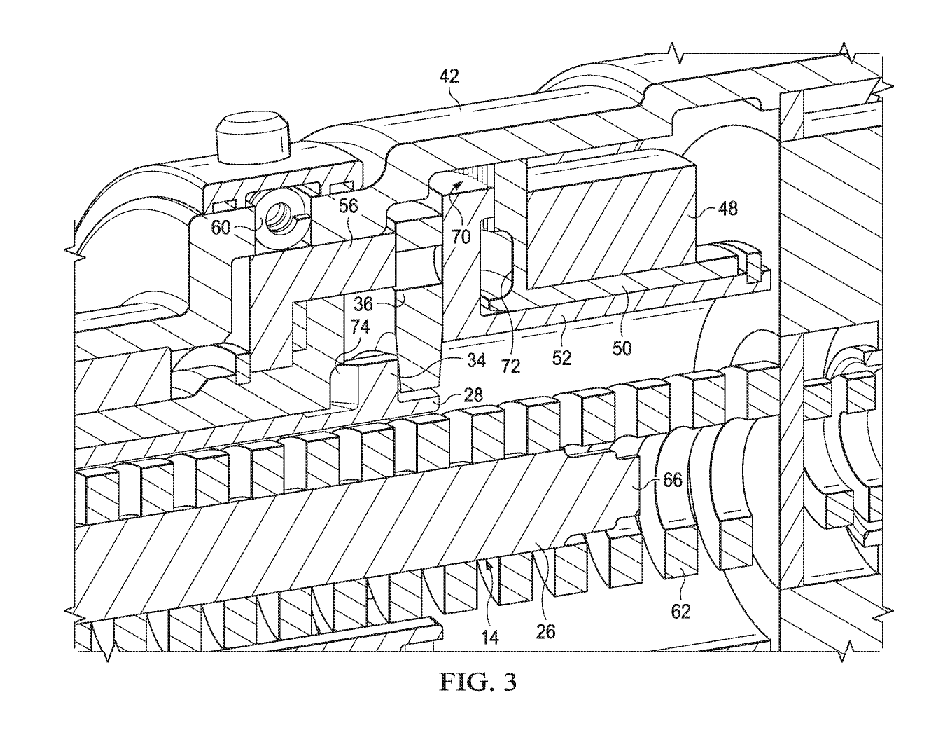

FIG. 3 illustrates an enlarged view of a cross-section of the electro-mechanical assembly 46 when the pressure relief valve 10 is in the closed mode of operation. In the illustrated example, first clutch ring 50 and second clutch ring 52 individually comprise teeth, generally 70, which may interlock with each other to engage first clutch ring 50 with second clutch ring 52. When teeth 70 of first clutch ring 50 are engaged with teeth 70 of second clutch ring 52, axial rotation of second clutch ring 52 is restricted as described above. Electromagnetic coil 48 may bias first clutch ring 50 towards and against second clutch ring 52 such that the teeth 70 of the individual first and second clutch rings 50, 52 respectively may be engaged as illustrated. The teeth 70 of the individual first and second clutch rings 50, 52 respectively may be positioned at any desired angle. For example, the teeth 70 may form a 45° angle in a preferred example. FIG. 3 also illustrates slot 72 in which the clutch biasing element 54 may be positioned. As described above, when electromagnetic coil 48 no longer biases first clutch ring 50 towards and against second clutch ring 52 such that the teeth 70 of the first and second clutch rings 50, 52 are engaged, clutch biasing element 54 may bias second clutch ring 52 away from first clutch ring 50 such that the teeth 70 of the first and second clutch rings 50, 52 are disengaged. Although interlocking teeth 70 are depicted as the engagement components of first and second clutch rings 50, 52 respectively, it is to be understood that any sufficient engagement mechanism may also be used. For example, the engagement may be due to friction between two flat parallel surfaces perpendicular to the electromagnetic force. As another example, the engagement may be due to friction between two concentric tapered cones with the electromagnetic force acting in the direction of the shared axis of cones.

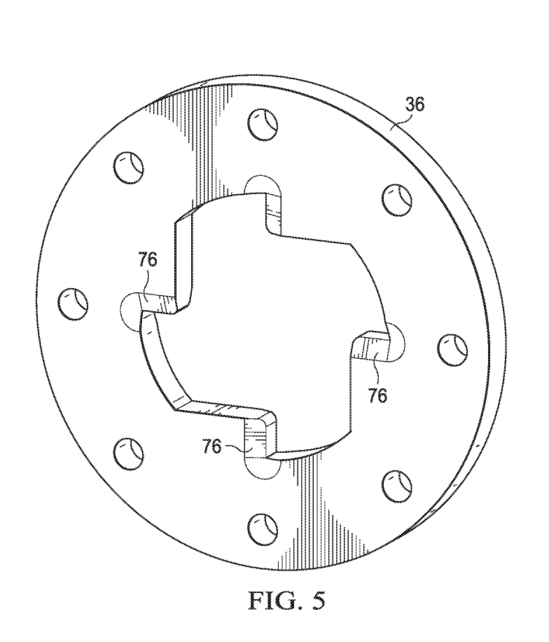

With continued reference to FIG. 3, the contact element 34 of the poppet contact member 28 of the poppet 14 is illustrated as contacting the poppet lock ring 36. The contact element 34 comprises a contact surface 74. The contact surface 74 may contact at least a portion of the poppet lock ring 36. As illustrated, the contact surface 74 may be angled such as to reduce the linear force created by the flow pressure generated from the overpressure event. In an example, the angle on the contact surface 74 of the contact element 34 may be less than a 90° angle. In a preferred example, the angle on the contact surface 74 of the contact element 34 may be a 25° angle. The angled contact surface 74 contacts an angled contact surface (i.e. angled contact surface 76 as illustrated in FIG. 5) of poppet lock ring 36. Force exerted by the angled contact surface 74 again the angled contact surface of the poppet lock ring induces axial rotation of the poppet lock ring 36 when the second clutch ring 52 is disengaged from the first clutch ring 50.

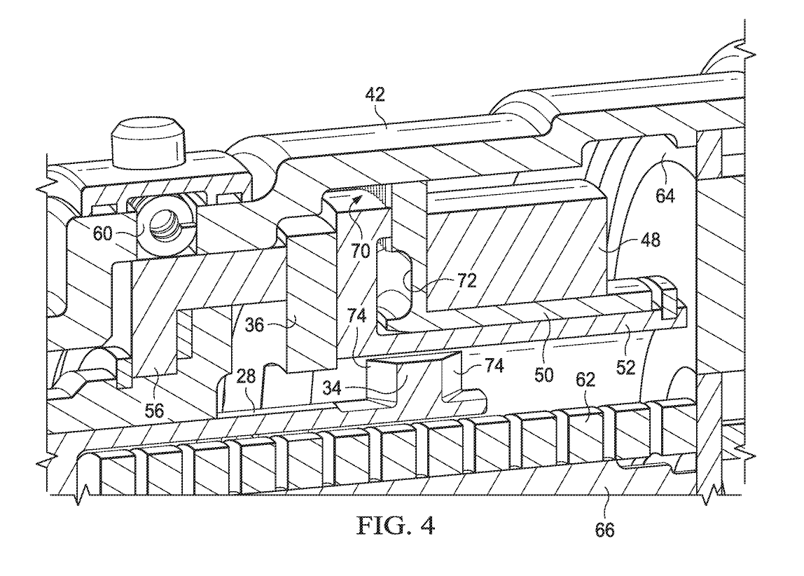

FIG. 4 illustrates an enlarged view of a cross-section of the electro-mechanical assembly 46 when the pressure relief valve 10 is in the open mode of operation. In the illustrated example, first clutch ring 50 and second clutch ring 52 are disengaged via the clutch biasing element (e.g., clutch biasing element 54 as illustrated in FIGS. 1 and 2) which would be disposed in slot 72, but has been removed for clarity of illustration. As such, second clutch ring 52 is allowed to rotate axially. As illustrated, the contact element 34 of the poppet contact member 28 of the poppet 14 has induced axial rotation of poppet lock ring 36 and the contact element 34 of the poppet contact member 28 has been pushed past poppet lock ring 36 via the force of the pressure flow against poppet 14 as discussed above. The contact element 34 comprises contact surfaces 74 on each side that may contact at least a portion of the poppet lock ring 36 to induce axial rotation of poppet lock ring 36 on either side. For example, if biasing element 60 resets poppet lock ring 36 to the default position through axial rotation, poppet spring 62 may induce axial rotation of poppet lock ring 36 through a force exerted against poppet lock ring 36 by contact element 34 when the flow pressure against poppet 14 has been reduced below a sufficient threshold. Therefore, contact member 34 may be reset to the position illustrated in FIG. 3 after the overpressure event has concluded by poppet spring 62, and poppet 14 may be reset to form a seal with main seal ring 22 when the flow pressure decreases below said threshold.

FIG. 5 illustrates the poppet lock ring 36 in isolation. As illustrated by FIG. 5, poppet lock ring 36 comprises contact surfaces 76 which may be contacted by the contact surfaces 74 of the contact element 34 (as illustrated in FIGS. 3 and 4). As with contact element 34, poppet lock ring 36 also comprises angled contact surfaces 76. The contact surfaces 76 are also angled on both sides in which poppet lock ring 36 may contact the contact surfaces 74 of the contact element 34. The angle may be any desirable angle. In an example, the angle may be less than 90°. In a preferred example, the angle is 25°. Because contact surfaces 74 and contact surfaces 76 are angled, the linear force exerted by contact element 34 against poppet lock ring 36 induces axial rotation of poppet lock ring 36 in the direction of the angle of the respective contact surfaces 74 and 76 as they slide past each other. The degree of the angle of the respective contact surfaces 74 and 76 also reduces the amount of electromagnetic force needed to maintain a closed position.

Examples of a pressure relief valve are provided. An example pressure relief valve comprises a main seal ring, a poppet configured to form a seal with the main seal ring, a dynamic wear sleeve configured to cover the main seal ring when the pressure relief valve is at least partially open and comprising a reduced cross-sectional area of the inner diameter at one end of the dynamic wear sleeve, an electro-mechanical clutch assembly, and wherein the pressure relief valve is actuated by the electro-mechanical clutch assembly. The electro-mechanical clutch assembly may not comprise a pneumatic or hydraulic mechanism. The electro-mechanical clutch assembly may comprise a poppet lock ring configured to contact the poppet at a contact surface. The contact surface may comprise an angle less than 90°. The electro-mechanical clutch assembly may comprise a plurality of clutch rings. A first clutch ring in a plurality of clutch rings may engage with a second clutch ring in the plurality of clutch rings. The engagement of the first clutch ring with the second clutch ring may restrict axial rotation of the second clutch ring. The electro-mechanical clutch assembly may comprise an electromagnetic coil. The electro-mechanical clutch assembly may be signaled to actuate by a pressure transducer. Alternatively, the electro-mechanical clutch assembly may be actuated without a pressure transducer. The pressure relief valve may comprise a biasing element configured to axially rotate the poppet lock ring. The pressure relief valve may comprise a spring attached to the poppet which biases the poppet towards the main seal ring. The dynamic wear sleeve may not cover the main seal ring when the poppet forms a seal with the main seal ring.

Methods of actuating a pressure relief valve are provided. An example method comprises providing a pressure relief valve comprising: a main seal ring, a poppet configured to form a seal with the main seal ring, a dynamic wear sleeve configured to cover the main seal ring when the pressure relief valve is at least partially open, an electro-mechanical clutch assembly comprising a poppet lock ring which is restricted from rotating in the axial direction, wherein the pressure relief valve is actuated by the electro-mechanical clutch; allowing the electro-mechanical clutch assembly to release the poppet lock ring such that the poppet lock ring may axially rotate, allowing the poppet to move away from the main seal ring such that the seal is broken. The electro-mechanical clutch assembly may not comprise a pneumatic or hydraulic mechanism. The electro-mechanical clutch assembly may comprise a poppet lock ring configured to contact the poppet at a contact surface. The contact surface may comprise an angle less than 90°. The electro-mechanical clutch assembly may comprise a plurality of clutch rings. A first clutch ring in a plurality of clutch rings may engage with a second clutch ring in the plurality of clutch rings. The engagement of the first clutch ring with the second clutch ring may restrict axial rotation of the second clutch ring. The electro-mechanical clutch assembly may comprise an electromagnetic coil. The electro-mechanical clutch assembly may be signaled to actuate by a pressure transducer. Alternatively, the electro-mechanical clutch assembly may be actuated without a pressure transducer. The pressure relief valve may comprise a biasing element configured to axially rotate the poppet lock ring. The pressure relief valve may comprise a spring attached to the poppet which biases the poppet towards the main seal ring. The dynamic wear sleeve may not cover the main seal ring when the poppet forms a seal with the main seal ring.

Systems for regulating pressure in a flow line are provided. An example system comprises a pressure relief valve comprising: a main seal ring, a poppet configured to form a seal with the main seal ring, a dynamic wear sleeve configured to cover the main seal ring when the pressure relief valve is at least partially open, and an electro-mechanical clutch assembly comprising a poppet lock ring which is restricted from rotating in the axial direction. The system further comprises a flow line coupled to an inlet of the pressure relief valve and a vent line coupled to an outlet of the pressure relief valve. The flow pressure in the flow line may be reduced by releasing at least a portion of the flow pressure through the outlet of the pressure relief valve when the flow pressure in the flow line surpasses a threshold pressure value. The inlet and the outlet of the pressure relief valve may not be in fluid communication unless the poppet lock ring is allowed to rotate in the axial direction. The electro-mechanical clutch assembly may not comprise a pneumatic or hydraulic mechanism. The electro-mechanical clutch assembly may comprise a poppet lock ring configured to contact the poppet at a contact surface. The contact surface may comprise an angle less than 90°. The electro-mechanical clutch assembly may comprise a plurality of clutch rings. A first clutch ring in a plurality of clutch rings may engage with a second clutch ring in the plurality of clutch rings. The engagement of the first clutch ring with the second clutch ring may restrict axial rotation of the second clutch ring. The electro-mechanical clutch assembly may comprise an electromagnetic coil. The electro-mechanical clutch assembly may be signaled to actuate by a pressure transducer. Alternatively, the electro-mechanical clutch assembly may be actuated without a pressure transducer. The pressure relief valve may comprise a biasing element configured to axially rotate the poppet lock ring. The pressure relief valve may comprise a spring attached to the poppet which biases the poppet towards the main seal ring. The dynamic wear sleeve may not cover the main seal ring when the poppet forms a seal with the main seal ring.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A pressure relief valve comprising:
a main seal ring,
a poppet configured to form a seal with the main seal ring,
a dynamic wear sleeve configured to cover the main seal ring when the pressure relief valve is at least partially open and comprising a reduced cross-sectional area of the inner diameter at one end of the dynamic wear sleeve,
an electro-mechanical clutch assembly, and
wherein the pressure relief valve is actuated by the electro-mechanical clutch assembly.

2. The pressure relief valve of claim 1, wherein the electro-mechanical clutch assembly does not comprise a pneumatic or hydraulic mechanism.

3. The pressure relief valve of claim 1, wherein the electro-mechanical clutch assembly comprises a poppet lock ring configured to contact the poppet at a contact surface.

4. The pressure relief valve of claim 3, wherein the contact surface comprises an angle less than 90°.

5. The pressure relief valve of claim 1, wherein the electro-mechanical clutch assembly comprises a plurality of clutch rings.

6. The pressure relief valve of claim 5, wherein a first clutch ring in the plurality engages with a second clutch ring in the plurality.

7. The pressure relief valve of claim 6, wherein the engagement of the first clutch ring with the second clutch ring restricts axial rotation of the second clutch ring.

8. The pressure relief valve of claim 1, wherein the electro-mechanical clutch assembly comprises an electromagnetic coil.

9. The pressure relief valve of claim 8, wherein the electro-mechanical clutch assembly is signaled to actuate by a pressure transducer.

10. The pressure relief valve of claim 8, wherein the electro-mechanical clutch assembly is actuated without a pressure transducer.

11. A method of actuating a pressure relief valve:
providing a pressure relief valve comprising:
a main seal ring,
a poppet configured to form a seal with the main seal ring,
a dynamic wear sleeve configured to cover the main seal ring when the pressure relief valve is at least partially open,
an electro-mechanical clutch assembly comprising a poppet lock ring which is restricted from rotating in the axial direction,
wherein the pressure relief valve is actuated by the electro-mechanical clutch;
allowing the electro-mechanical clutch assembly to release the poppet lock ring such that the poppet lock ring may axially rotate,
allowing the poppet to move away from the main seal ring such that the seal is broken.

12. The method of claim 11 wherein the pressure relief valve further comprises a biasing element configured to axially rotate the poppet lock ring.

13. The method of claim 11 wherein the pressure relief valve further comprises a spring attached to the poppet which biases the poppet towards the main seal ring.

14. The method of claim 11, wherein the dynamic wear sleeve does not cover the main seal ring when the poppet forms a seal with the main seal ring.

15. The method of claim 11, wherein the electro-mechanical clutch assembly does not comprise a pneumatic or hydraulic mechanism.

16. The method of claim 11, wherein the poppet lock ring comprises a contact surface configured to contact the poppet, and wherein the contact surface comprises an angle less than 90°.

17. The method of claim 11, wherein the electro-mechanical clutch assembly comprises a first clutch ring and second clutch ring.

18. A system for regulating pressure in a flow line comprising:
a pressure relief valve comprising:
a main seal ring,
a poppet configured to form a seal with the main seal ring,
a dynamic wear sleeve configured to cover the main seal ring when the pressure relief valve is at least partially open,
an electro-mechanical clutch assembly comprising a poppet lock ring which is restricted from rotating in the axial direction,
a flow line coupled to an inlet of the pressure relief valve,
a vent line coupled to an outlet of the pressure relief valve.

19. The system of claim 18 further configured to relieve flow pressure in the flow line by releasing at least a portion of the flow pressure through the outlet of the pressure relief valve when the flow pressure in the flow line surpasses a threshold pressure value.

20. The system of claim 18, wherein the inlet and the outlet of the pressure relief valve are not in fluid communication unless the poppet lock ring is allowed to rotate in the axial direction.
